(19) United States
(12) Patent Application Publication
(10) Pub. No.: US 2023/0268562 A1
(43) Pub. Date: Aug. 24, 2023

(54) Flexible Battery Terminal

(71) Applicant: BSL CH AG, Chur (CH)

(72) Inventors: Perry Jones, Mytchett (GB); Noamaan Siddiqi, Mytchett (GB)

(73) Assignee: BSL CH AG, Chur (CH)

(21) Appl. No.: 18/112,473

(22) Filed: Feb. 21, 2023

Related U.S. Application Data
(60) Provisional application No. 63/312,200, filed on Feb. 21, 2022.

(51) Int. Cl. H01M 10/42; H01M 50/284; B60L 50/60

(52) U.S. Cl. CPC H01M 10/425; H01M 50/284; B60L 50/66; H01M 2220/20

(57) ABSTRACT

A flexible battery terminal for an electric vehicle is provided that permits a greater range of permissible connection orientations between, for example, a PCB and a battery cell.

### CROSS REFERENCE TO RELATED APPLICATION

This application claims priority and benefit to U.S. Provisional Application No. 63/312,200, filed on Feb. 21, 2022 and titled Flexible Battery Terminal, the contents of which are incorporated herein by this reference as though set forth in their entirety.

### FIELD OF USE

A flexible battery terminal providing a greater range of permissible connection orientations in, for example, electrically powered vehicles with lithium-ion battery cells.

### BACKGROUND

A battery cell, in a typical automotive battery application, must have a reliable connection to the electrical system of the car and is typically monitored for voltage. Connection and monitoring solutions usually involve the use of wires and crimp terminals to connect the monitoring circuitry, normally situated on a Printed Circuit Board (PCB), with the battery cells themselves. These battery-to-PCB connections are usually facilitated by a rigid direct connection of the PCB with the cell terminals. Because vehicles move, they generate vibrations which may sometimes jostle or otherwise disturb the electrical equipment. It is desired to have a battery-to-PCB connection that has a greater range of flexibility and alignment, thereby permitting a larger tolerance for continuous satisfactory connection.

### SUMMARY OF THE DISCLOSURE

In embodiments, a flexible battery terminal is provided for an electric traction battery in any electrically powered vehicle in which a Printed Circuit Board (PCB) makes multiple direct electrical connections to an array of lithium-ion Cells. For example, in embodiments, the flexible battery terminal provides a greater range of flexibility for connecting a flexible PCB to an electrical terminal for sensing battery cell voltage.

In embodiments of the flexible battery terminal, the terminal is soldered, press-fitted, or otherwise affixed to pre-defined mounting slots in a PCB in multiple locations in order to line up mechanically with pre-tapped holes in a battery cell's high current terminals.

In embodiments, a flexible battery terminal is attached to a battery cell by a machine screw or by laser welding. In those embodiments, the flexible battery terminal is shaped such that it holds the screw by mechanical compliance and lines up with each threaded hole or terminal pad in an array of mounted battery cells, regardless of any slight misalignment of cells due to mechanical tolerances found in the manufacture of cells and support structure and also tolerances found in battery module assemblies.

Embodiments of the flexible battery terminal also permit connection between the battery and the PCB to continue even when mechanical displacements occur during service life of the battery that, for example, might be due to vibration and/or thermal expansion of the cells and support structures.

Embodiments of the flexible battery terminal are designed such that it prevents undue force being applied to the PCB and its mountings, and as a consequence prevents undue force being applied to the cells themselves during assembly and throughout service life of the batteries.

### BRIEF DESCRIPTION OF THE DRAWINGS

The accompanying drawings, which are incorporated in and constitute a part of this specification, illustrate embodiments of the disclosure and together with the general description of the disclosure given above and the detailed description of the drawings given below, serve to explain the principles of the disclosure. In certain instances, details that are not necessary for an understanding of the disclosure or that render other details difficult to perceive may have been omitted.

FIG. 1 is an embodiment of a Flexible Battery Terminal (FBT) 1.

FIG. 2 is an embodiment of a FBT 1 mounted in a Printed Circuit Board (PCB) 14.

FIG. 3 depicts various deflections of an embodiment of a FBT 1.

FIG. 4 depicts a range of mechanical alignments supported by an embodiment of an elongated mounting hole 2 of a FBT 1.

FIG. 5 is an embodiment of a mounting arrangement comprising a FBT 1 mounted on a PCB 14 within an electric vehicle.

### DETAILED DESCRIPTION OF EMBODIMENTS

Before the present systems and methods are disclosed and described, it is to be understood that the systems and methods are not limited to specific methods, specific components, or to particular implementations. It is also to be understood that the terminology used herein is for the purpose of describing particular embodiments only and is not intended to be limiting. Various embodiments are described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

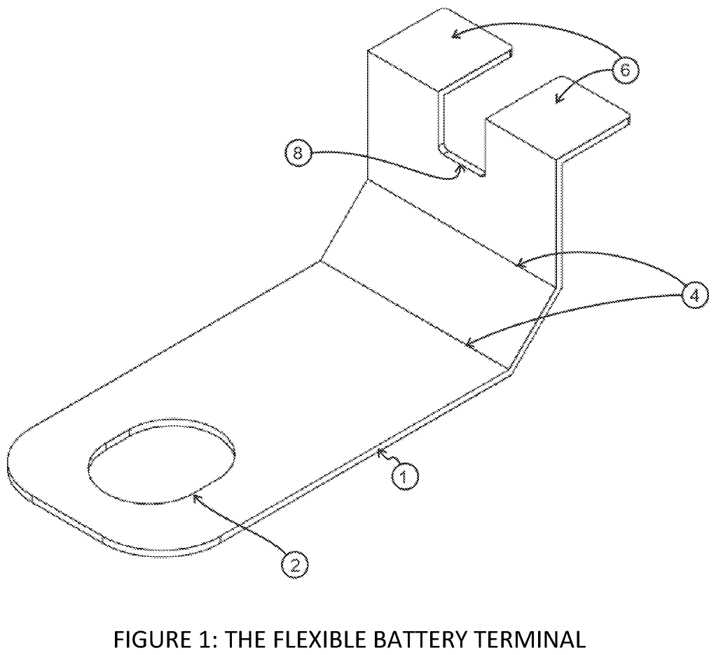

FIG. 1 is an embodiment of a Flexible Battery Terminal (FBT) 1, also called a Flexible Battery Cell Sensing Terminal. In this embodiment, the FBT 1 has an elongated mounting hole 2 on one end of its body and a double bend portion 4 on its body that leads up to a bifurcated portion comprising two Printed Circuit Board (PCB) solder terminals 6 with a slot 8 in between the solder terminals 6.

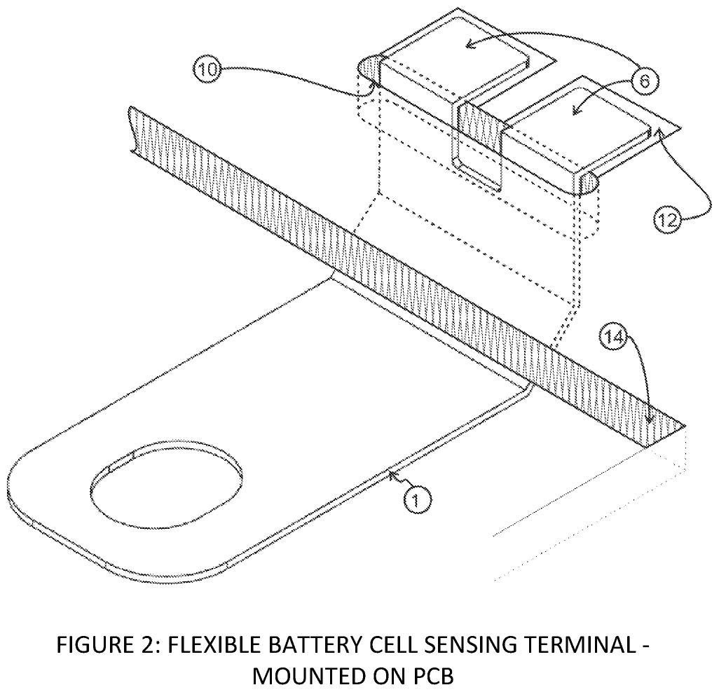

FIG. 2 is an embodiment of a FBT 1 shown in a typical PCB 14 mounted arrangement.

In this embodiment, the two terminals 6 of the FBT 1 are positioned through a slot 10 in the PCB and are soldered to pre-defined pads 12 on the PCB.

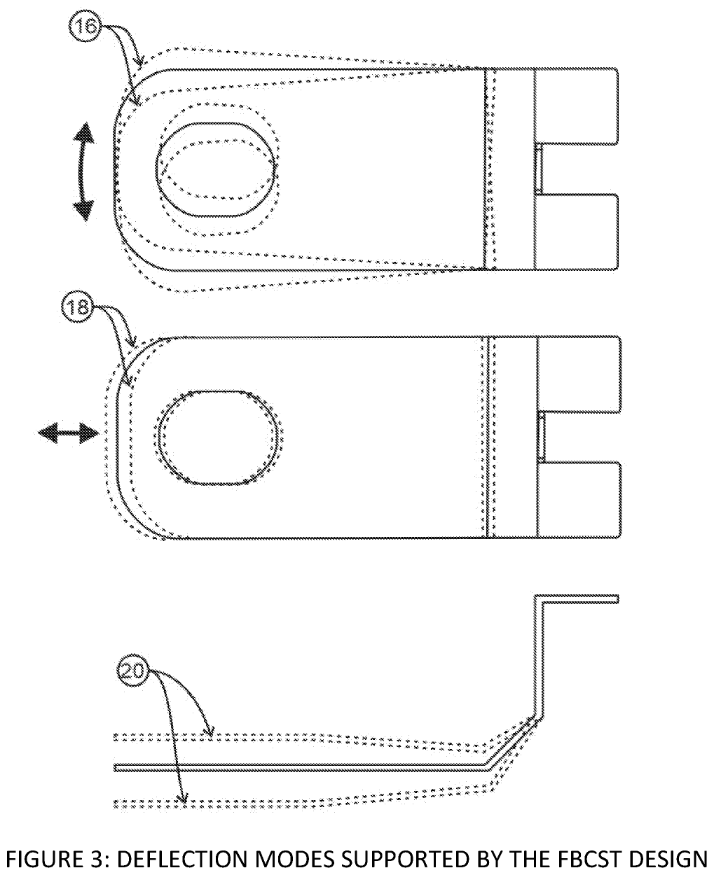

FIG. 3 depicts how an embodiment of a FBT 1 can respond to various forces. For example, in response to forces or vibrations in an electric vehicle, a FBT 1 can deflect in various directions, such as in the lateral directions 16 and 18 and in the vertical direction 20, responding to deflection between the cell mounting hole 2 and the PCB solder terminals 6 shown in FIGS. 1 and 2.

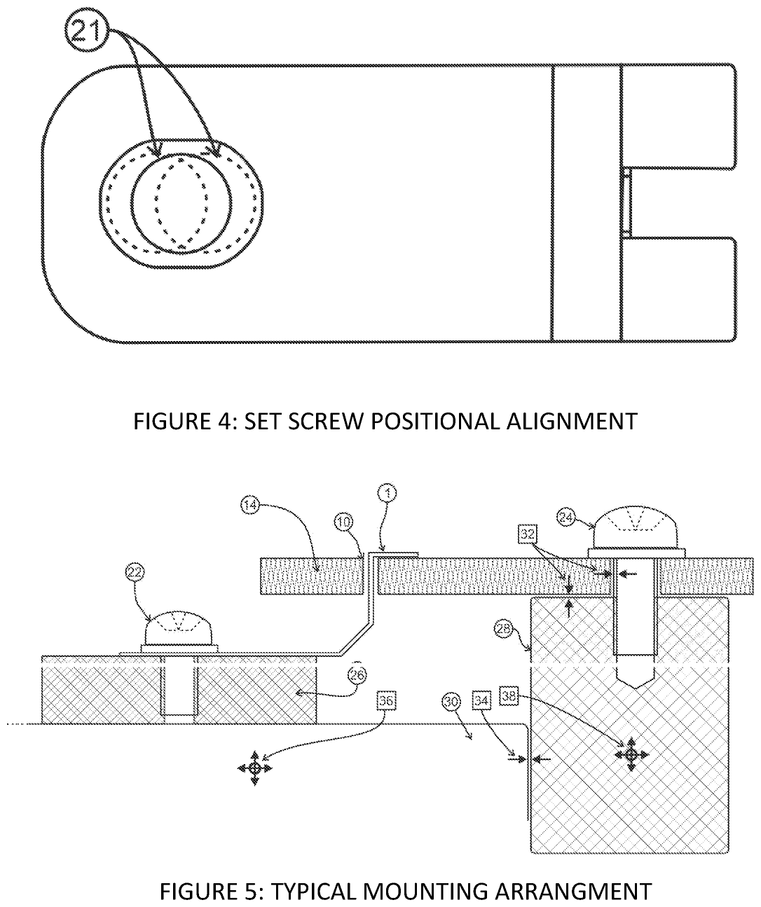

FIG. 4 depicts how an embodiment of the FBT 1 is flexible in its mounting to a PCB. For example, FIG. 4 shows how an elongated mounting hole 2 accepts a range of mechanical alignments 21 before a set screw is tightened against the PCB and mounts the FBT 1 to the PCB.

FIG. 5 depicts a functional layout of a typical environment for a FBT 1. In this embodiment, a cut through view of a typical terminal mounting point is depicted, of which a typical cell module would have multiple mounting points. FIG. 5 depicts a wider context for the FBT 1, including a cell structure 30, a high current terminal 26 for the cell structure 30 and a terminal sensing point attached by a set screw 22. Also shown is a support structure 28 that is partly physically supporting the cell 30 but also providing a mounting point for the PCB 14 attached by a further set screw 24.

In the embodiment of an electro-mechanical arrangement depicted in FIG. 5, battery cells inside a battery pack are arranged in rows with a support structure pressing them together with a pre-determined force with insulators in between the cells. In an exemplary battery cell arrangement, a support structure prevents the cells from moving relative to one another in a vertical direction. The support structure can also serve another purpose in providing a means for mounting a battery cell management PCB containing circuits that can provide cell management functions, such as charge balancing in embodiments.

In these embodiments, a cell management PCB 14 has a direct cell-to-cell electrical connection in order to take cell voltage readings. Such direct cell-to-cell electrical connections are most accurately facilitated by making a direct connection to the individual battery cell terminals. In embodiments, battery cell terminals have a high current connection and a threaded stud or hole from which traction power is drawn. The high current connections are often connected to the next battery cell in a series of cells by a large metal busbar and fixed with nuts or bolts. At each battery cell terminal, however, there are typically smaller threaded fixing points designed exclusively for connecting to circuits for cell charge balancing and voltage measurements.

There are numerous mechanical constraints to consider when in designing a system to electrically connect a cell management PCB directly to sense terminals. For example, movement in the following areas depicted in FIG. 5 could affect the connection point of a battery cell on a PCB: (1) manufacturing tolerances in the assembly process of the cell support structure due to numerous mechanical fixings and tightening torques 38; (2) placement tolerance in the process of fixing the PCB to the cell support structure in manufacturing 32; (3) thermal expansion/contraction in the cell support structure and/or the cells relative to one another 34, 36, 38; (4) individual cell aging and swelling during normal service life 36; and (5) relative deflection due to vibration of the cells and their support structures 34, 36, 38.

In embodiments, a FBT 1 is designed to mount via a set screw 22 directly to a cell terminal 26. At the PCB end, where circuits measure the cell voltage and where the balancing takes place, the FBT 1 is soldered into a pair of surface mount solder pads.

In embodiments, a solution to dealing with the aforementioned impinging tolerances and other effects on alignment is provided by the following design features: by making the FBT 1 out of a thin flexible metal with spring-like qualities, and appropriately dimensioned such that it is able to tolerate deflections elastically, but also able to be soldered easily; and by bifurcating the soldered end of the FBT 1 to form two legs 6 shown in FIG. 1 and providing a clearance slot 8 between the ends and also a double bend 4, it is thus endowed with the ability to articulate sufficiently in the plane of the PCB (see 16 and 18 as shown in FIG. 3). Also, in embodiments, by virtue of support offered by a PCB mounting slot 10, the FBT 1 can articulate vertically relative to the plane of the PCB without causing undue stress between the PCB solder pads 12 and the two terminal legs 6 (see 20 in FIG. 3). In embodiments, the FBT 1 is made from a piece of metal of any thickness appropriate for its desired flexibility and rigidity; for example, in embodiments, it is approximately 0.15 mm-0.35 mm in thickness. In embodiments, the FBT 1 is formed through any appropriate process, including stamping, laser cutting, or other method. In embodiments, the FBT 1 is made up of any appropriate flexible metal, for example, conductive metallic alloys of copper, zinc, nickel, or aluminum, including nickel silver, plated copper, plated aluminum, or brass.

What is claimed is:

1. A flexible battery terminal comprising: a body made of a flexible metal, the body comprising a proximal and a distal end with a middle portion in between, the distal end comprising two legs defining a slot, the middle portion comprising a double bend in the flexible metal such that the distal and proximal portions are in different planes, and the proximal end comprising an elongated mounting hole.

2. The flexible battery terminal of claim 1, wherein the flexible battery terminal is configured to connect to a printed circuit board, and wherein the flexible battery terminal is configured to permit articulation in a plane vertical to the Printed Circuit Board (PCB) without causing undue stress between the PCB and the two legs of the flexible battery terminal.

3. The flexible battery terminal of claim 1, wherein the flexible battery terminal is configured to connect to a PCB, and wherein the flexible battery terminal is configured to permit articulation in a plane of the PCB without damaging the connection between the PCB, the two legs of the flexible battery terminal, the battery cell, and the elongated mounting hole.

4. An electrically powered vehicle comprising: a battery cell, an electrical system configured to be monitored for voltage using a PCB, and a flexible battery terminal configured to provide an electrical connection between the PCB and the battery cell, wherein the flexible battery terminal is configured to provide alignment and tolerate deflections elastically for the electrical connection between the flexible battery terminal and the battery cell or between the flexible battery terminal and the PCG.

5. The battery powered vehicle of claim 4, wherein the flexible battery terminal is soldered into a pair of surface mount solder pads.

6. The battery powered vehicle of claim 4, wherein the flexible battery terminal comprises a thin flexible metal with spring like qualities.

7. The battery powered vehicle of claim 4, wherein the flexible battery terminal comprises a bifurcated end forming at least two legs, thereby providing at least one clearance slot between the at least two legs.

8. The battery powered vehicle of claim 7, wherein the flexible battery terminal further comprises a double bend that is configured to articulate in a plane of the PCB without causing undue stress between the PCB and the at least two legs of the bifurcated end of the flexible battery terminal.

9. The battery powered vehicle of claim 7, wherein the flexible battery terminal further comprises a PCB mounting slot that provides support such that flexible battery terminal can articulate vertically relative to the plane of the PCB without causing undue stress between the PCB and the at least two legs of the bifurcated end of the flexible battery terminal.

10. The battery powered vehicle of claim 7, wherein the flexible battery terminal is made from a piece of flexible metal of any thickness appropriate for its desired flexibility and rigidity and wherein the flexible battery terminal is formed through any appropriate process, for example stamping or laser cutting.
